(19) United States
(12) Patent Application Publication
(10) Pub. No.: US 2010/0054545 A1
(43) Pub. Date: Mar. 4, 2010

(54) Method and apparatus for displaying properties onto an object or life form

(76) Inventor: Larry Elliott, Valley Village, CA (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/921,407

(22) PCT Filed: Jun. 2, 2006
(86) PCT No.: PCT/US06/21450

§ 371 Date: Sep. 10, 2009

Related U.S. Application Data
(60) Provisional application No. 60/686,405, filed on Jun. 2, 2005.

(51) Int. Cl. G06K 9/00; H04N 5/222; H04N 5/228; H04N 9/31; H04N 5/30; G01N 23/04; G06F 3/048

(52) U.S. Cl. 382/115; 348/333.1; 348/222.1; 348/744; 382/128; 382/100; 348/162; 348/E05.031; 348/E09.025; 348/E05.022; 348/E05.085; 378/62; 715/772

(57) ABSTRACT

In a system and method for displaying properties on an object, an imager is configured to capture an image of an object of interest and generate image data from the captured image, wherein the image data comprise information of the object of interest that cannot be detected by the naked eye, and an image processing unit transforms the imaged data into a viewable format. An image projector displays an image in accordance with the Image data transformed by the image processing unit onto the object of interest.

### FIELD OF THE INVENTION

The present invention relates generally to imaging technology and, more particularly, to a system and method for displaying properties onto an object or life form.

### BACKGROUND OF THE INVENTION

A thermal image can be used to see invisible heat variations of a target object. To view the thermal image, the user must obtain a thermal imager and look through the viewer of the thermal imager. Alternatively, the video output of the thermal imager can be remotely viewed on a TV or computer monitor. It would be desirable to obtain and view images in a manner more convenient to users.

### SUMMARY OF THE INVENTION

According to an aspect of the invention, a system and method for displaying properties on an object includes an imager configured to capture an image of an object of interest and generate image data from the captured image, wherein the image data comprises information of the object of interest that cannot be detected by the naked eye, and an image processing unit that transforms the image data into a viewable format. The system and method further includes an image projector that displays an image in accordance with the image data transformed by the image processing unit onto the object of interest.

According to another aspect of the invention, the image is displayed in direct proportion dimensionally to the object of interest.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram of a display system consistent with the present invention.

FIG. 2 is an example of an arrangement of optics for use in the display system of FIG. 1

FIGS. 3A-3D are examples of adjustments made for aligning the field of view of the imager with the projection of the image projector of the display system of FIG. 1.

FIG. 4 is an example of an area that can be covered using the display system of FIG. 1.

FIG. 5 is an example of a thermal image of a human.

FIGS. 6A-6D show an example of imaging, processing, and projecting a vector outline image on an object of interest consistent with the present invention.

FIGS. 7A-7D show an example of imaging, processing, and projecting a raster line image on an object of interest consistent with the present invention.

FIG. 8 is an example of a control panel that can be used in the display system of FIG. 1.

FIG. 9 is an example of projecting an image on objects of interest at a distance consistent with the present invention.

FIG. 10 is an example of highlighting objects of interest in the example of FIG.

FIG. 11 is an example of providing a frame to the highlighted objects of interest in the example of FIG. 10.

FIGS. 12A-12C show examples of varying frame shapes that can be projected in the display system of FIG. 1.

FIG. 13 is an example of an alternative application of the system of FIG. 1 for controlling a fire.

FIG. 14 is an example of an alternative application of the system of FIG. 1 for controlling an air mass.

FIG. 15 is an example of an application of the display system of FIG. 1 for identifying stress areas in a bridge.

FIGS. 16A-16B are examples of an application of the display system of FIG. 1 for identifying hot spots in an electrical power apparatus.

FIG. 17 is an example of an application of the display system of FIG. 1 for displaying the contents of a container.

### DETAILED DESCRIPTION OF PREFERRED EMBODIMENTS

In a display system consistent with the present invention, an observer can see an object or life form in a manner that cannot be seen with the naked eye. Such properties are extracted from data that is provided by either a thermal imager, an x-ray machine or any other examining device capable of revealing properties that are contained in or radiating from the object or life form that are not visible to the human eye. These properties can also be, for example, the contrasting phenomenon created by the object or life form and its physical surroundings, as detected by the examining device.

The detected properties are displayed onto the object or life form by the projection of light. This projection of light onto the object or life form can either be a direct representation of the data obtained from the examining device or a pertinent extraction thereof. Furthermore, the properties displayed onto the object or life form are preferably displayed in such a way so as to be in direct proportion dimensionally to the properties that are found by the examining device to be contained in or radiating from the object or life form. The result of the projection enables anyone in the proximity of the projection to see the properties displayed onto the object or life form that is being detected by the imager.

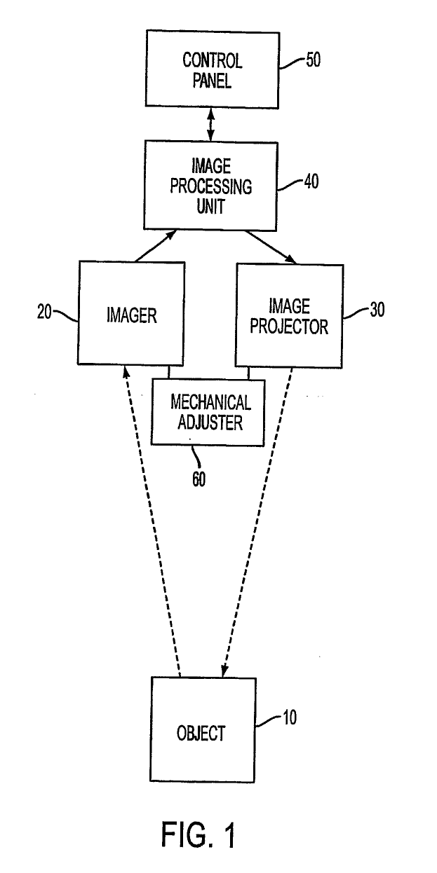

FIG. 1 is a block diagram of a display system consistent with the present invention. As shown in FIG. 1, the display system includes an object of interest 10 (hereinafter object 10), an imager 20, an image projector 30, an image processing unit 40, a control panel 50, and a mechanical adjuster 60. The object 10 can be any type of object or life form that can be viewed and captured by the imager 20. For example, the object 10 may be humans, animals, buildings, containers, bridges, electrical power apparatuses, etc.

The imager 20 can be implemented, for example, as a thermal imager, an X-ray machine, or any other type of imaging device that can detect and capture characteristics of an object that cannot be seen with the naked eye, such as multi-spectral imagers, radio-wave imagers, electromagnetic field imagers, ultrasonic imagers, ultraviolet imagers, gamma ray imagers, microwave imagers, radar imagers, magnetic resonance imagers (MRIs), and infrared imagers (near, mid, and far, which is the thermal infrared imager). The image projector 30 can be implemented, for example, as a laser projector or video projector. An exemplary commercially available laser projector is the Colorburst by Lumalaser. The image processing unit 40 preferably includes processing hardware, such as a CPU, microprocessor, or multi-processor unit, software configured to transform image data captured by the imager 20 into projection data that can be displayed by the image projector 30, and memory or storage for storing the software and other instructions used by the image processing unit 40 to perform its functions. To transform the image data captured by the imager 20 into projection data that can be displayed by the image projector 30, the image processing unit 40 can be configured with commercially available software applications, such as the LD2000 from Pangolin Laser Systems Inc.

The control panel 50 preferably includes a display, such as an LCD, plasma, or CRT screen, and an input unit, such as a keyboard, pointing device, and/or touch pad. The display of the control panel 50 shows the image captured by the imager 20. The input unit includes various controls that permit the user to make changes to the display system, such as the field of view of the imager 20, the positioning of the imager 20 and the image projector 30, and the addition of elements to be projected by the image projector 30.

In general, the image projector 30 can be mounted on top of the imager 20, although other configurations, such as side by side, are also possible. Regardless of the arrangement between them, the mechanical adjuster 60 adjusts the relative positioning of the imager 20 with respect to the image projector 30. To obtain a proper alignment between the image projector 30 and the imager 20, the mechanical adjuster 60 adjusts the vertical, horizontal and axial (azimuth) positioning of the imager 20 and/or the image projector 30. The imager 20 and the image projector 30 are properly aligned when the image captured by the imager 30 is aligned with the image projected by the image projector 30. The adjustment by the mechanical adjuster 60 can be made to either the imager 20 or the image projector 30 or to both. In addition, the adjustment of the mechanical adjuster 60 can be done manually by a user or can be done automatically through inputs made to the control panel 50. As will be described herein, the control panel 50 can be used to provide electronic adjustments, independent of the mechanical adjuster 60, to provide further refinements to the alignment of the imager 20 and the image projector 30.

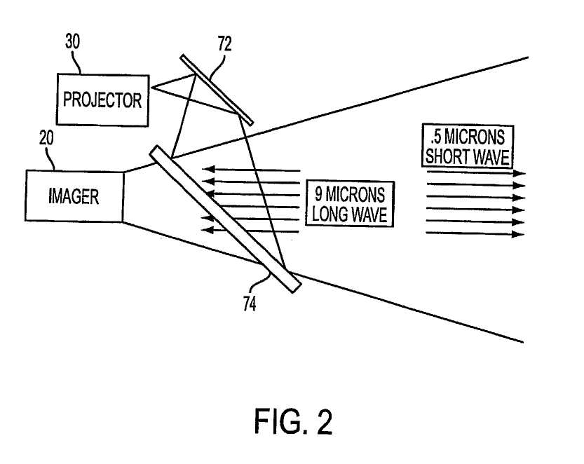

FIG. 2 is an example of an arrangement of optics for use in the display system of FIG. 1. As shown in FIG. 2, the display system can be configured to include an optical system comprising a mirror 72 and a transmitter/reflector 74. The transmitter/reflector 74 is designed to transmit or pass through certain electromagnetic waves and to reflect certain other electromagnetic waves. For example, the transmitter/reflector 74 can have a certain threshold such that electromagnetic waves with a wavelength under the threshold (e.g., visible light) are reflected, and electromagnetic waves with a wavelength greater than the threshold (e.g., thermal waves) are transmitted.

As shown in FIG. 2, the imager 20, such as a thermal imager, receives electromagnetic waves having a 9 micron wavelength, which is transmitted through transmitter/reflector 74. The image projector 30, such as a laser projector, projects an image comprising electromagnetic waves having a 0.5 micron wavelength onto the mirror 72, which reflects the electromagnetic waves to the transmitter/reflector 74. Because the electromagnetic waves from the image projector 30 are sufficiently short, i.e., shorter than the threshold of the transmitter/reflector 74, the transmitter/reflector 74 reflects the light waves from the image projector toward the object imaged by the imager 30.

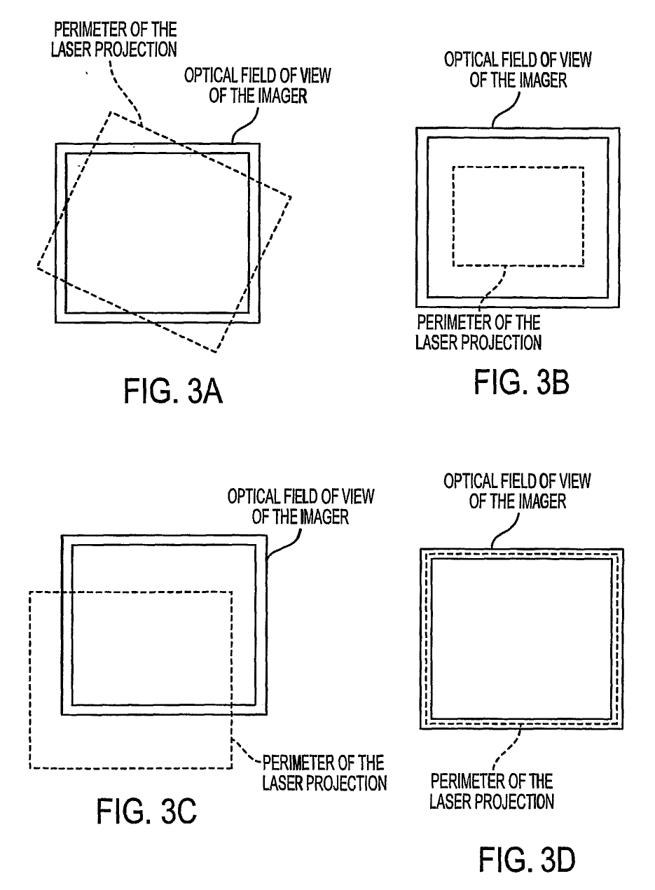

FIGS. 3A-3D are examples of adjustments made for aligning the field of view of the imager with the projection of the image projector of the display system of FIG. 1. As shown in FIGS. 3A-3D, the double, solid line box corresponds to the optical field of view of the imager 20, and the dashed-line box corresponds to the perimeter of the projection of the image projector 30. In FIG. 3A, the projection of the image projector 30 is off-axis from the optical field of view of the imager 20. To correct for this misalignment, the mechanical adjuster 60 is used to change the axial (azimuth) positions of the imager 20 and the image projector 30 with respect to each other.

In FIG. 3B, the projection of the image projector 30 is smaller in the vertical and horizontal directions with respect to the optical field of view of the imager 20. To correct for this misalignment, an electronic adjustment of the projection of the image projector 30 can be made. The electronic adjustment can be made, for example, through the control panel 50 or through a direct adjustment on the image projector 30. The electronic adjustment can be used to adjust the vertical and horizontal size of the projection of the image projector 30. The electronic adjustment can also be made to adjust the vertical and horizontal size of the imager 20, i.e., the field of view of the imager 20, through the control panel 50 or through direct adjustment of the imager 20.

In FIG. 3C, the projection of the image projector 30 is too low and too far to the left from the optical field of view of the imager 20. To correct for this position misalignment, the projection of the image projector 30 is adjusted to center the projection horizontally and vertically. This adjustment can be done using the mechanical adjuster 60 and/or the electronic adjustment.

FIG. 3D shows the projection of the image projector 30 properly aligned with the optical field of view of the imager 20. By making this alignment, the image projector 30 can project an image onto the object 10 that is in direct proportion dimensionally to the object 10 itself. There is alignment when the dashed-line box is within the double, line box.

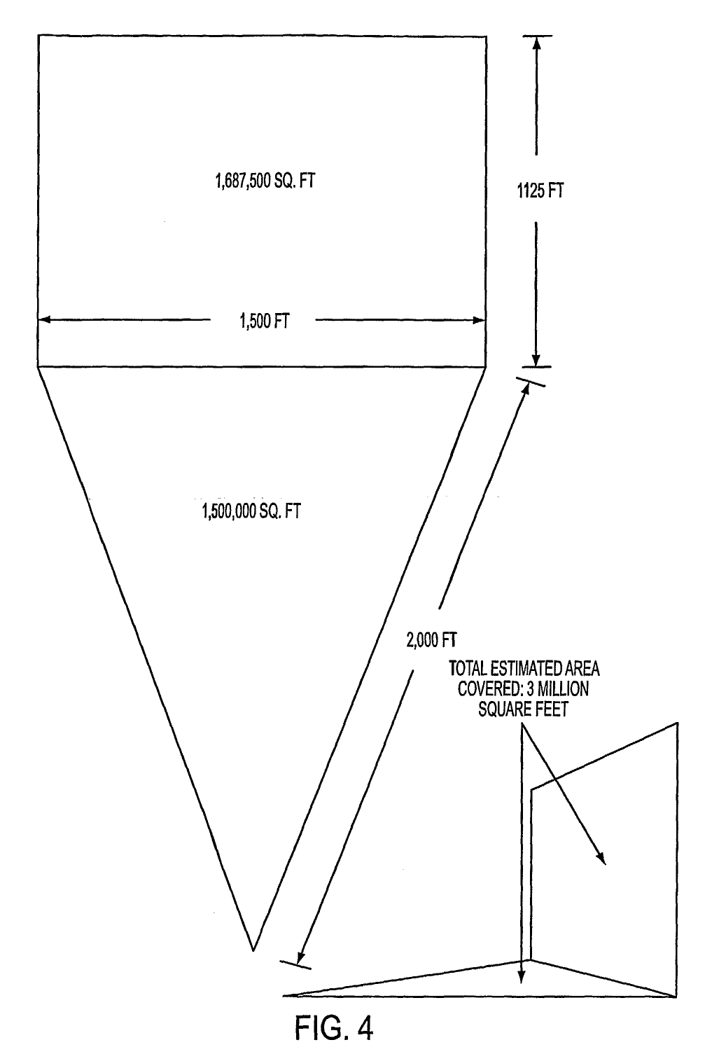

FIG. 4 is an example of an area that can be covered using the display system of FIG. 1. In general, the wider the field of view of the imager 20, the shorter the distance at which the imager 20 can effectively detect objects. Conversely, the shorter the field of view of the imager 20, the farther the distance at which the imager 20 can effective detect objects. In FIG. 4, if the imager 20 is implemented as a thermal imager, such as the Raytheon 640×480 Common Uncooled Engine, then with a horizontal field of view at 45 degrees, the imager 20 can detect objects or activity up to 2000 feet away. At this distance, the field of view would measure at 1500 feet×1125 feet. At ground level, this would cover 1,500,000 square feet. In a vertical plane at 2000 feet, the imager would detect 1,687,500 square feet.

At night or at twilight, the images projected by the image projector 30 can be seen very clearly at distances of better than 2000 feet. When implemented as a laser projector, the image projector 30 projects a sharp image that does not need to be focused. To be visible, the laser used is preferably in the green wavelength, around 532 nm. The color green is preferable because it is the brightest color perceptible to the human eye, although other visible colors can be used. The field of view, with a display system viewing at 45 degrees, can be expanded to 360 degrees by using multiple units side by side each viewing 45 degrees until 360 degrees are obtained.

The imager 20 can be implemented with a lens assembly that allows only 3 to 6 degrees field of view horizontally, but providing an ability to capture images at greater distances. Such an implementation could be useful at border crossings. At 3 to 6 degrees field of view, the imager 20 can detect a human presence up to and sometimes well over a mile away. In addition, even low powered lasers emitted by the image projector 30 can be seen at these distances.

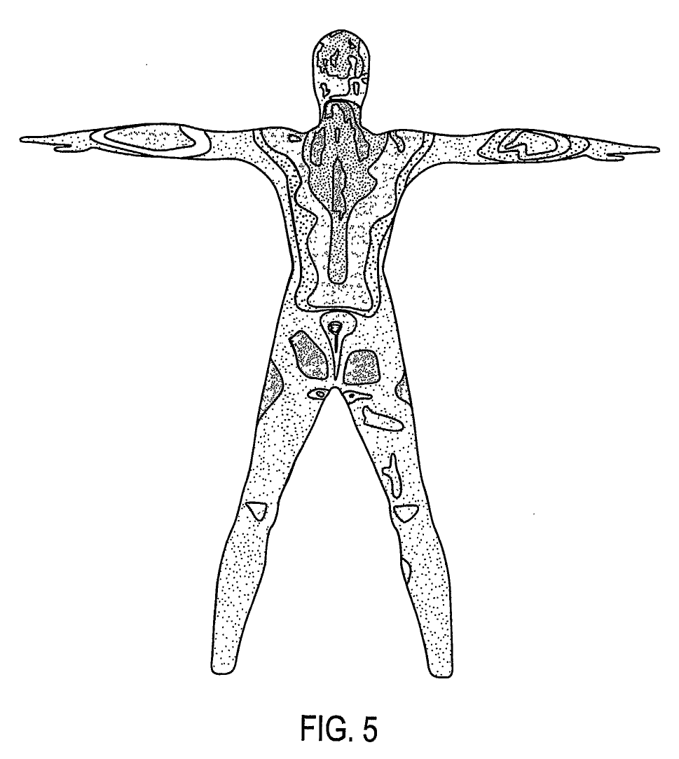

FIG. 5 is an example of a thermal image of a human. As shown in FIG. 5, the imager 20, implemented as a thermal imager, captures the thermal image of a human. The captured image is processed by the image processing unit 40 and provided to the image projector 30, which projects the thermal image of the human directly onto the human.

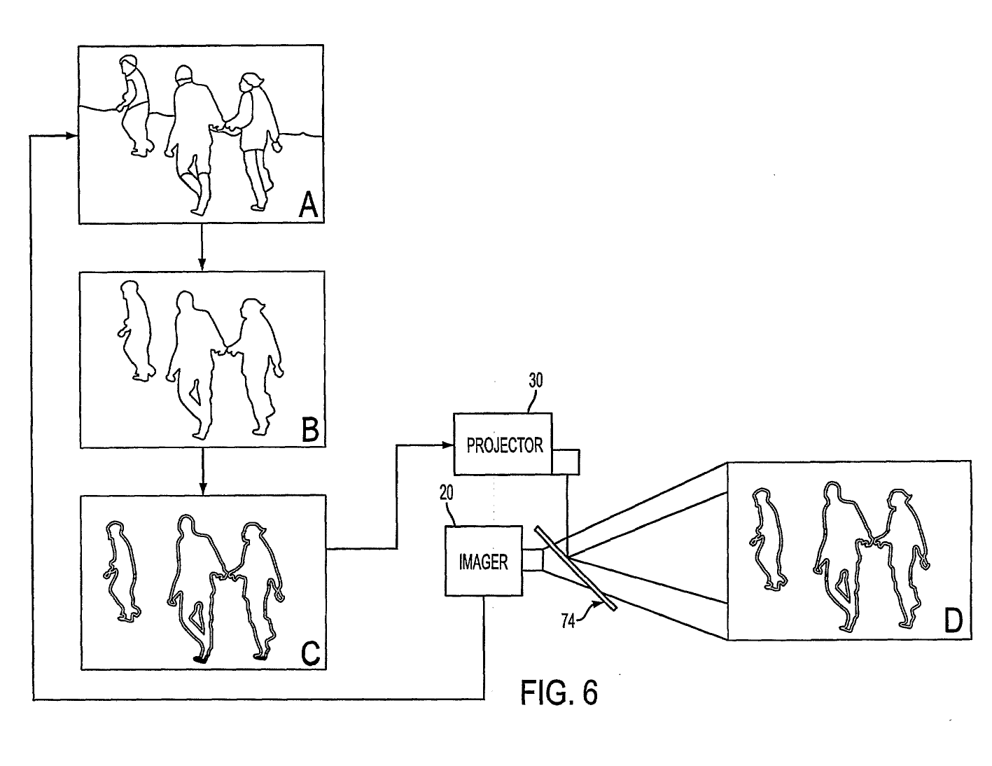

FIGS. 6A-6D show an example of imaging, processing, and projecting a vector outline image on an object of interest consistent with the present invention. FIG. 6A shows the video output from the imager 20, such as when implemented as a thermal imager. The video output from the imager 20 can be displayed on the display of the control panel 50.

FIG. 6B shows the image of the object 10 captured by the imager 20 after converting the analog signal provided by the imager 20 into a digital signal and adjusting the contrast and brightness so that the highest contrast can be seen against the background. The analog to digital conversion and brightness and contrast adjustment are performed by the image processing unit 40. With this contrast against the background, as shown in FIG. 6C, a vector outline is generated where white meets black. The generation of the vector outline can also be performed by the image processing unit 40, and can be implemented in the image processing unit 40 with a vector graphics software program as are know in the art.

The image data corresponding to the vector outline generated by the image processing unit is provided to the image projector 30, which projects the outline over the object 10 that was imaged by the imager 20, as shown in FIG. 6D. The image projector 30 thus visibly outlines the body of each object 10 captured by the imager 20.

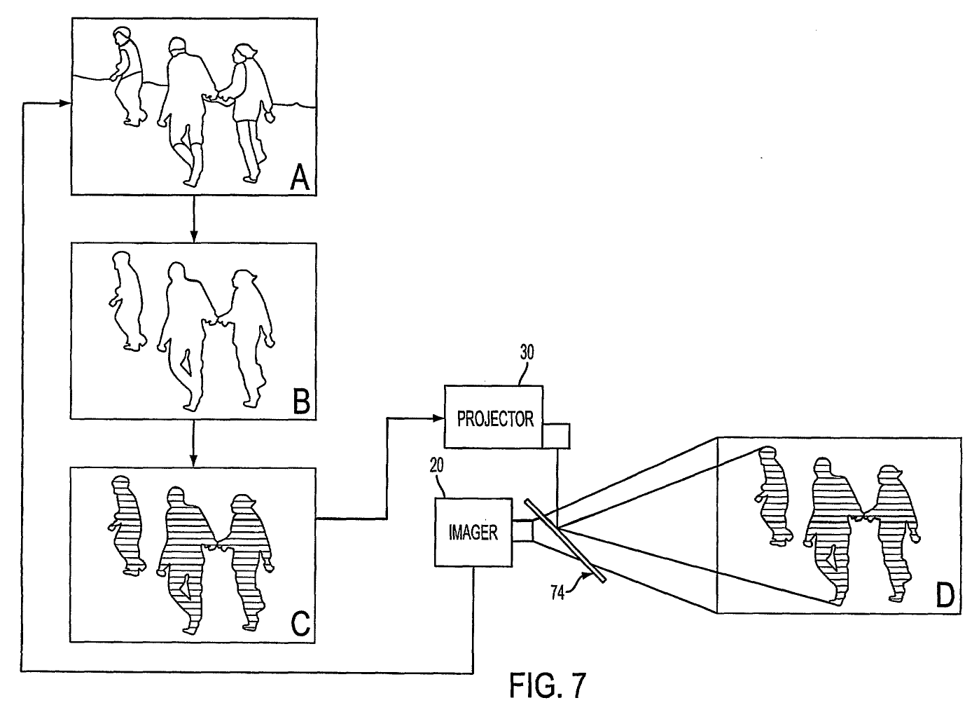

FIGS. 7A-7D show an example of imaging, processing, and projecting a raster line image on an object of interest consistent with the present invention. FIGS. 7A and 7B are the same as FIGS. 6A and 6B, respectively, described above. Accordingly, description of FIGS. 7A and 7B are omitted. In FIG. 7C, instead of generating a vector outline where white meets black, as shown in FIG. 6C, raster lines are generated wherever white is present. The generation of raster lines can be performed by the image processing unit 40, and can be implemented in the image processing unit 40 with a raster graphics software program as are know in the art.

The image data corresponding to the raster lines generated by the image processing unit is provided to the image projector 30, which projects the raster lines over the object 10 that was imaged by the imager 20, as shown in FIG. 6D. The image projector 30 thus visibly illuminates the body of each object 10 captured by the imager 20.

Accordingly, using the display system of FIG. 1, it is possible to outline the object 10 imaged by the imager 20, as shown in FIGS. 6A-6D, or to illuminate the object 10, as shown in FIGS. 7A-7D. In addition, the outline and illuminating, as well as any other type of image projection, can be performed in real time. To do so, the video output of the imager 20, while it is imaging, is provided in real time to the image processing unit 40, which processes these video frames one by one in real time, such as with a video-to-vector graphics software program. The image processing unit 40 analyzes each frame of video one by one in real time and creates a vector line(s) (or raster line or other type of image for projection) wherever white meets black on that frame. The created vector line (or raster line or other type of image projection) replaces the frames of video one by one in real time with vector outline frames (or raster line frames or other type of image projection frames). These newly created graphics frames are delivered electronically one by one in real time to the image projector 30, which in turn projects them directly over the object 10 that is being detected by the imager 20.

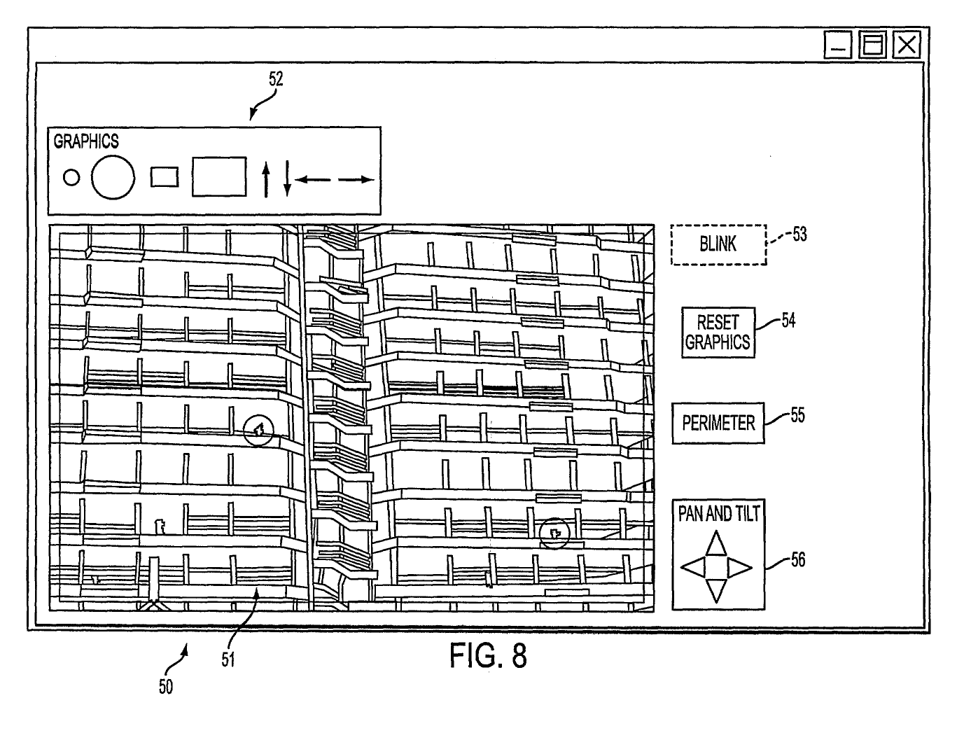

FIG. 8 is an example of a control panel that can be used in the display system of FIG. 1. As shown in FIG. 8, the control panel 50 includes a display 51, graphics keys 52, blink key 53, reset key 54, perimeter key 55, and pan and tilt key 56. The display 51 can be implemented, for example, as a CRT, LCD, plasma, or other type of video display. The graphics keys 52, blink key 53, reset key 54, perimeter key 55, and pan and tilt key 56 can be implemented as buttons on a panel separate from the display 51 or as a touch panel on the display 51 itself.

The graphics keys 52 can be used to block out portions of the image captured by the imager 20 and to add images to the image captured by the imager 20. As shown in FIG. 8, the graphics keys 52 include two different sized circles, two different sized rectangles, and four arrows. The circles and arrows are graphics that can be added to the image captured by the imager 20, and the solid rectangles are graphics that can be used to block out portions of the image captured by the imager. It should be understood that other shapes can be used for the graphics keys 52, both for graphics to be added to the image and for blocking out part of the image. The graphics keys 52 can also include a changeable size tool that permits the user to demarcate the size of an image portion deleted or an image added. The position of the deleted image portion or the added image can be set using the pan and tilt key 52. Alternatively, a pointing device such as a mouse or pen device can be used to set the position. It is also possible to permit a user to touch the location at which the selected graphic is placed.

The blink key 53 is selected when the user wants the projected image in a particular area to blink. To do so, the user can touch the area of the video screen (or demarcate the area with a changeable size tool in conjunction with a pointing device) and then select the blink key 53. This action causes the projected image in that area to blink, which is useful in drawing a viewer's attention to the blinking object.

The reset key 54 removes any image portions deleted and any images added by the graphics keys 52. The perimeter key 55 adds a frame to the view on the display 51 and to the image projected by the image projector 30. The frame added by the perimeter key corresponds to the field of view of the imager 20. The pan and tilt key 56 can be used, for example, to move the position the imager 20 (and correspondingly the position of the image projector 30), to change the size of the field of view of the imager 20, and to move the placement of objects added to the display 51.

In the exemplary image shown in the display 51 in FIG. 8, a portion of a building is shown to include five human objects that are identifiable by the imager 20, such as by their heat signature when the imager 20 is implemented as a thermal imager. The display 51 also includes two particular human objects that have circular images added by the graphics keys 52. The user may add these circular images to identify high value objects from among the objects captured by the imager 20 so that when the image projector 30 displays the image with the added circles onto the building itself including the human objects, anyone viewing the image displayed by the image projector 30 will see the circles around the high valued objects, and thus be able to discriminate objects of interest from objects that are not of interest. For example, in a military context, the circle objects can be enemy combatants and the non-circled objects can be friendly combatants. In addition to the circular images, a frame can be added to the overall image. The frame provides an outline of the actual image captured by the imager 20, i.e., the field of view of the imager 20. The frame can be useful as it shows viewers exactly how much or how little the imager 20 is seeing.

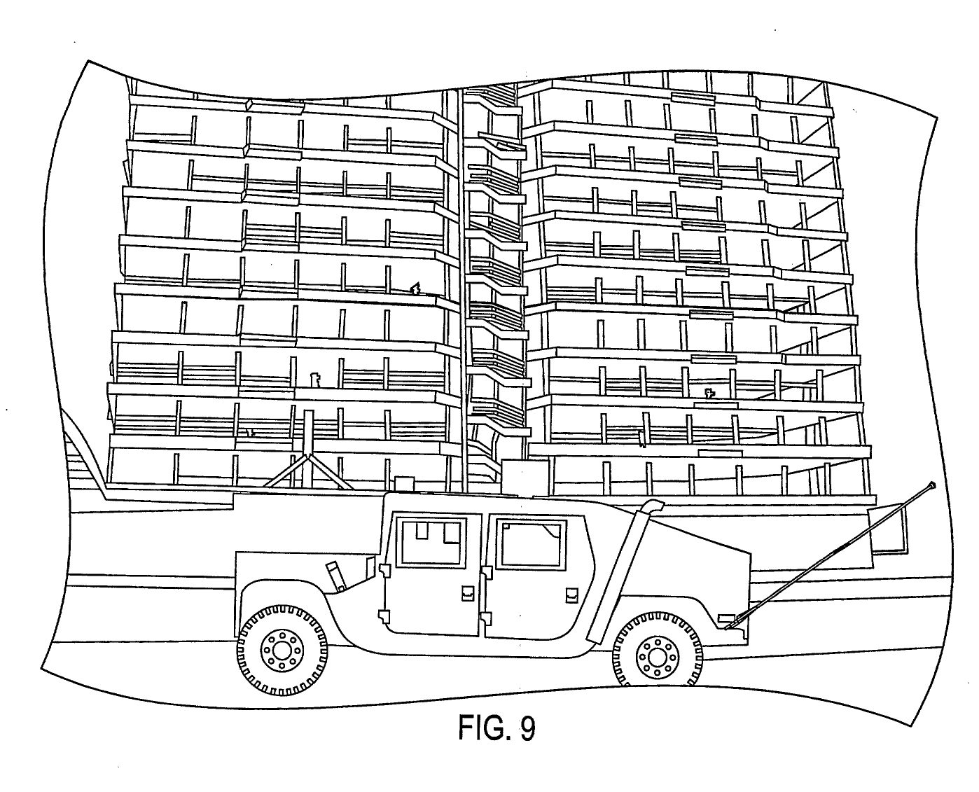

FIG. 9 is an example of projecting an image on objects of interest at a distance consistent with the present invention. As shown in FIG. 9, a vehicle in which the display system has been implemented is positioned at night at a distance from the same building shown in FIG. 8. Through the use of the system, the imager 20 can identify objects, in this case human objects, at a distance and illuminate them with the image projector 30. For covert operations, a laser emitted by the image projector 30 can be in the near field infrared range, around 940 nm, which is invisible to the naked eye and thus allow only those with standard night vision capabilities to view the projection.

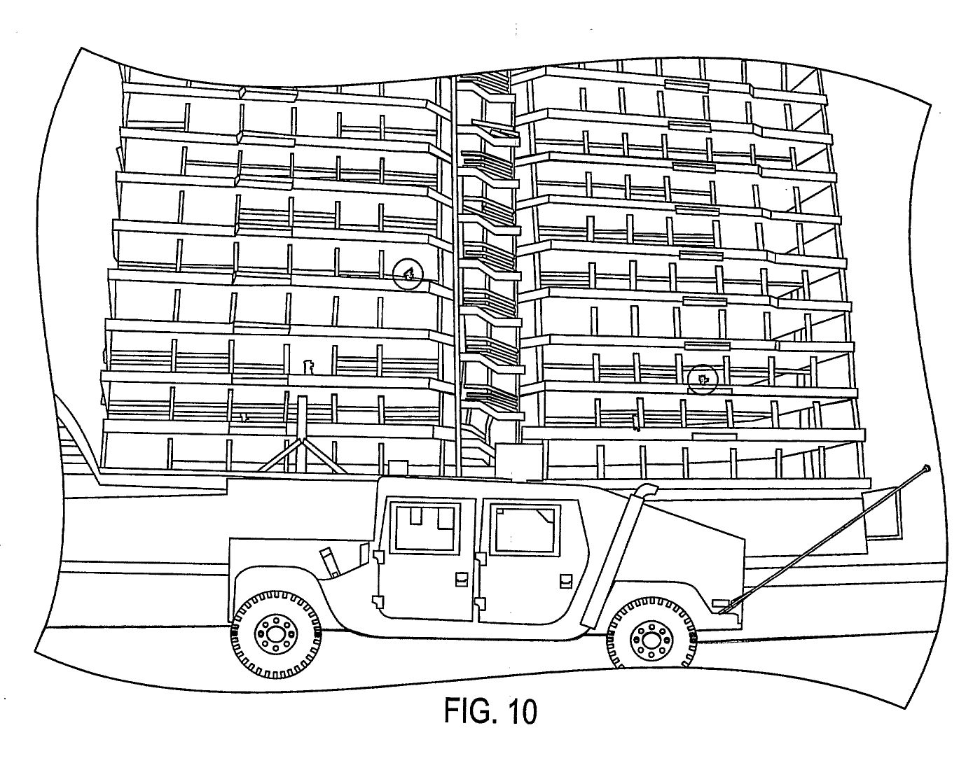

FIG. 10 is an example of highlighting objects of interest in the example of FIG. 9. In particular, FIG. 10 shows two specific objects that are surrounded by circles, which are graphics added using the image add keys 54 of the control panel 50. The image processing unit 40 can be configured to follow a highlighted object (e.g., an object around which a graphic is added) if the object moves while being imaged by the imager 20. For example, if the objects surrounded by circles in FIG. 10 are moving, the image processing unit 40 can process the image so that the circles remain around the moving objects.

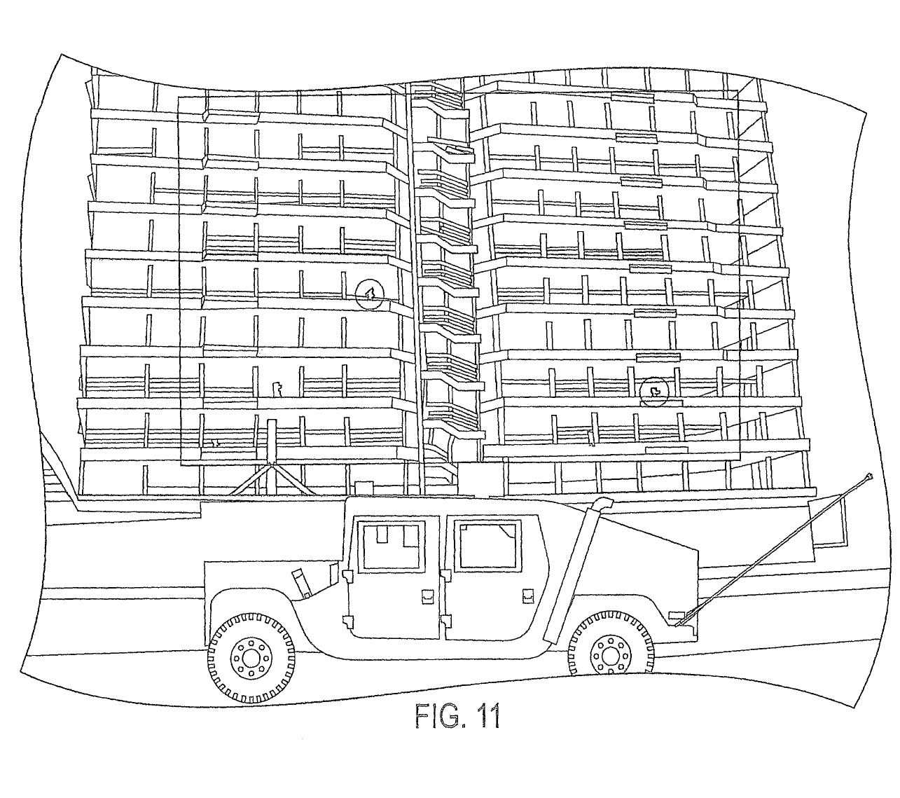

FIG. 11 is an example of providing a frame to the highlighted objects of interest in the example of FIG. 10. In particular, the frame in FIG. 11 shows how much of the building is being imaged by the imager 20.

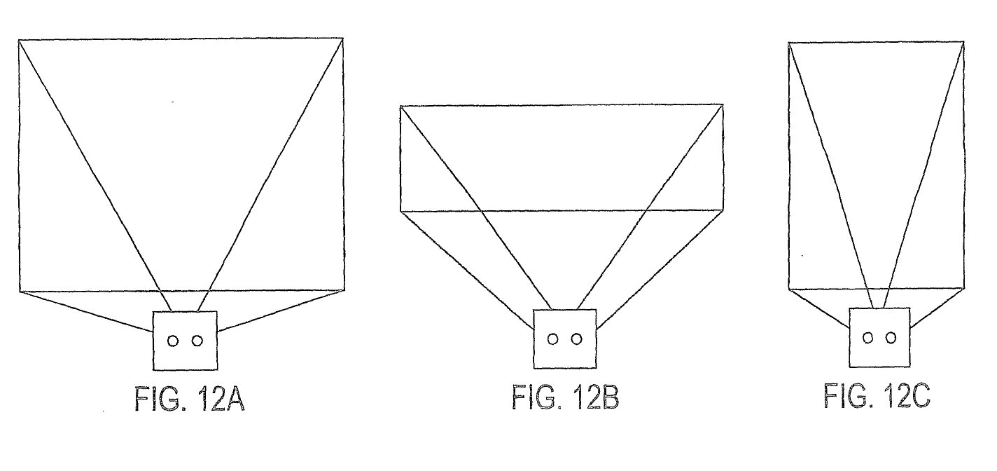

FIGS. 12A-12C show examples of varying frame shapes that can be projected in the display system of FIG. 1. In the display system of FIG. 1, the horizontal and vertical size of this projected window (field of view) can be adjusted independently to fit the specific needs of the operator. In FIG. 12A, the image projector 30 displays a full screen, which is the default size of the projected window. FIG. 12B shows the display of a panoramic view in which the height of the projection window is made smaller. In FIG. 12C, the image projector displays a vertical view in which the width of the projection window is narrowed, such as if only a tall building needs to be examined. With these various window dimensions set, the image projector 30 does not project beyond those dimensions even though the imager 20 may capture an image larger than the window dimensions.

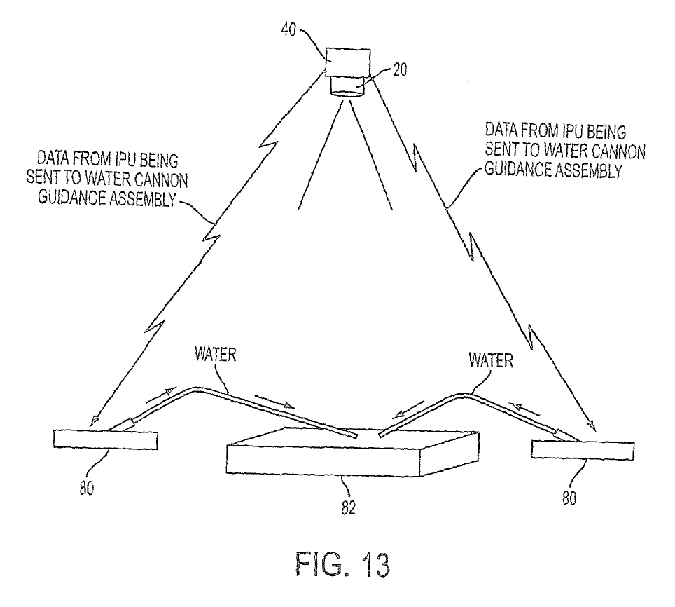

FIG. 13 is an example of an alternative application of the system of FIG. 1 for controlling a fire. As shown in FIG. 13, the system including the image processing unit 40 and the imager 20 can be suspended over an object on fire, such as a ship 82. The display system can be suspended, for example, by a helicopter, a balloon, an airplane, or other aerial vehicle. If implemented as a thermal imager, the imager 20 provides a thermal image of the ship 82, which identifies the hot spots, i.e., the fire locations, to the image processing unit 40. The image processing unit 40 can be configured to identify the hot spots from the thermal image and provide that information to water cannon and guidance assemblies 80. More specifically, the image processing unit 40 can be configured to map digitally the perimeter of the entire theater of combustion including all hot spots and any thermal data relevant to this unstable condition. Based on this information, the assemblies 80 can be automatically directed to position and provide water to the most needed spots on the ship 82 and thus effectively and efficiently put out the fire on the ship. The identified hot spots can also determine the force at which the assemblies 80 provide water to the fire. Although assemblies 80 are described as using water, it should be understood that other fire retardants can be used.

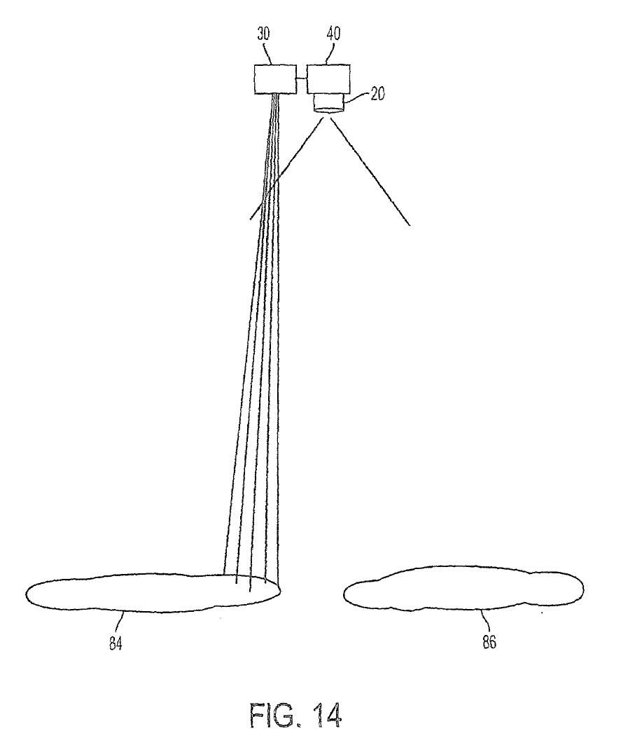

FIG. 14 is an example of an alternative application of the system of FIG. 1 for controlling an air mass. Like the system in FIG. 13, the system here would be carried by an aerial vehicle that is capable of positioning the system over a cold air mass 84 and a warm air mass 86. In the example of FIG. 14, the cold air mass 84 is on a trajectory course towards a warm air mass 86 or visa versa. When this condition exists, a hurricane or other violent weather front may start to form. As shown in FIG. 14, the imager 20, implemented as a thermal imager, with an aerial view of the air masses 84, 86 provides thermal data to the image processing unit 40. The image processing unit can be configured to map digitally the entire thermal domain relevant to this weather event and calculate where the image projector 30, implemented as a powerful overhead laser, would best be directed in order to warm part or all of the cold air mass 84 so as to mitigate or stop the inevitable weather condition.

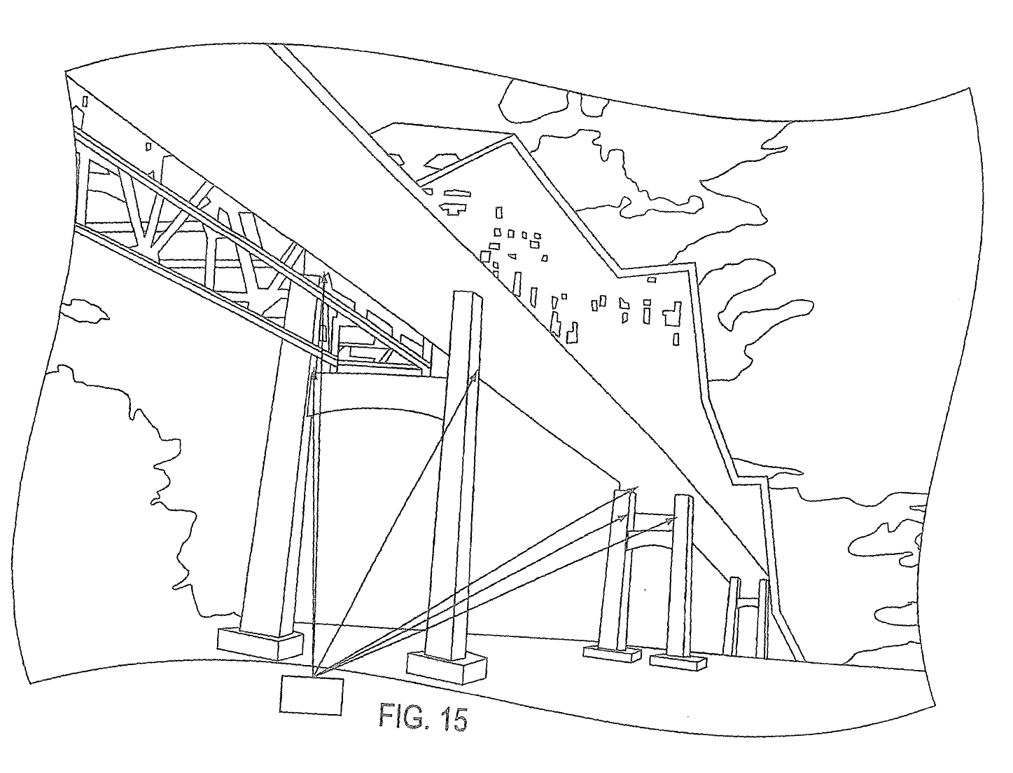

FIG. 15 is an example of an application of the display system of FIG. 1 for identifying stress areas in a bridge. As shown in FIG. 15, the imager 20 images at least a portion of the bridge. If implemented as a thermal imager, the image captured by the imager 20 would highlight the areas of the bridge that are mechanically stressed. The image is then processed by the image processing unit 40, which provides the processed image to the image projector 30, and the image projector 30 projects the image onto the bridge so that viewers can witness exactly where on the bridge the stress spots are located.

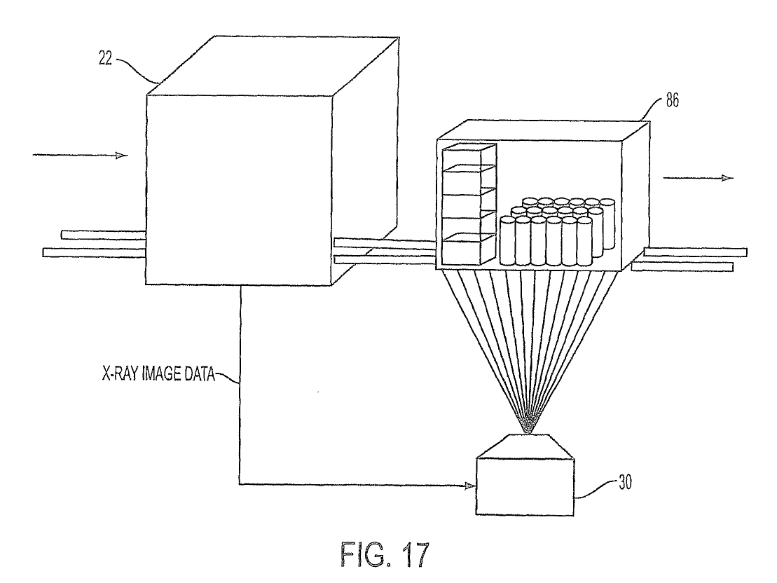

FIG. 16A-16B are examples of an application of the display system of FIG. 1 for identifying hot spots in an electrical power apparatus. As shown in FIGS. 16A-16B, the imager 20 images at least a portion of the electrical power apparatus. If implemented as a thermal imager, the image captured by the imager 20 would highlight the areas of the electrical power apparatus that correspond to hot spots. The image is then processed by the image processing unit 40, which provides the processed image to the image projector 30, and the image projector 30 projects the image onto the electrical power apparatus so that viewers can witness exactly where on the electrical power apparatus the hot spots are located. Thus, using the display system of FIG. 1 for bridges and electrical power apparatuses, multiple users can see on the objects themselves exactly where items of interest are located.

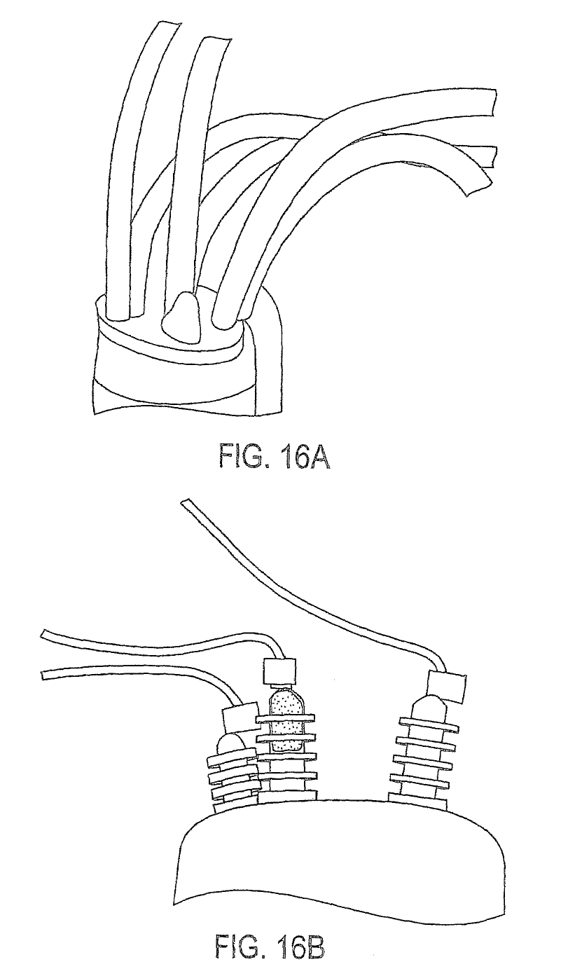

FIG. 17 is an example of an application of the display system of FIG. 1 for displaying the contents of a container. In this example, the imager 20 is preferably implemented as an X-ray device. In this implementation, the display system can be used to detect and display the contents of a shipping container 86. In particular, the shipping container 86 passes through an X-ray area 22, which corresponds to a region that can be captured by the imager 20. The X-ray image data is provided to the image processing unit 40, which transforms the X-ray image data into an image that can be projected by the image projector 30. The image projector 30 projects the image onto the side of the container 86 so that viewers can witness the shape and position of the contents of the container without having to open the container.

It would be desirable in some instances to have the display system configured to remember first findings and display them longer, i.e., not display the image in real time. For example, if a person is detected and that person recognizes that his position is now being displayed, he would likely try to duck out of the sight of the imager 20, which would in turn stop the display system from displaying his position further. By using a first glance capture mode, the display system can be configured to remember the last position that was displayed by the image projector 30 and direct the image projector 30 to continue displaying that specific area for a predetermined period of time. This would give the viewers additional time to evaluate these sightings.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments (which can be practiced separately or in combination) were chosen and described in order to explain the principles of the invention and as practical application to enable one skilled in the art to make and use the invention in various embodiments and with various modifications suited to the particular uses contemplated. It is intended that the scope of the invention be defined by the claims appended hereto and their equivalents.

1-30. (canceled)

31. A system for displaying properties on an object comprising:
an imager configured to capture an image of at least one object of interest in a field of view and generate image data from the captured image, wherein the image data comprises information of the object of interest that cannot be detected by the naked eye;
an image processing unit that extracts a portion of the image data and transforms the extracted portion of the image data into a viewable format; and
an image projector that displays an image in accordance with the extracted portion of the image data transformed by the image processing unit onto the object of interest.

32. A system according to claim 31, wherein the imager is a thermal imager, and the captured image is a thermal image of the object of interest.

33. A system according to claim 32, wherein the object of interest is a person, and the image projector displays a thermal image of the person onto the person in direct proportion dimensionally to the person.

34. A system according to claim 31, wherein the imager is an X-ray machine, and the captured image is an X-ray of the object of interest.

35. A system according to claim 34, wherein the object of interest is a container including contents, and the image projector displays an X-ray image of the contents of the container onto a wall of the container in direct proportion dimensionally to the contents.

36. A system according to claim 31, further comprising:
an electronic image adjustment unit configured to adjust a position and size of the image displayed by the image projector; and
a mechanical adjustment unit configured to adjust a relative position between the imager and the image projector.

37. A system according to claim 35, wherein the electronic adjustment unit and the mechanical adjustment unit are used to align the image displayed by the image projector so that the displayed image is in direct proportion dimensionally to the object upon which the image is projected.

38. A system according to claim 31, wherein the image processing unit is configured to:
receive frames of the image data from the imager in real time; and
maximize a contrast between the objects of interest and a background in each frame received from the imager in real time.

39. A system according to claim 38, wherein the image processing unit is further configured to:
identify a vector line wherever white image data meets black image data in each frame in real time;
create a vector outline frame based on the identified vector lines for each respective frame of image data received from the imager in real time; and
provide the vector outline frames to the image projector,
wherein the image projector displays the image in accordance with the vector outline frames provided by the image processing unit.

40. A system according to claim 38, wherein the image processing unit is configured to:
generate raster line data where the white image data is present in each respective frame of image data received from the imager in real time; and
create raster line frames based on the generated raster line data for each respective frame of image data received from the imager in real time; and
provide the raster line frames to the image projector,
wherein the image projector displays the image in accordance with the raster line frames provided by the image processing unit.

41. A system according to claim 31, further comprising a control panel configured to provide image controls in response to inputs made through the control panel, wherein each image control is configured to adjust the operation of at least one of the imager, the image processing unit, and the image projector.

42. A system according to claim 41, wherein the control panel includes a blinking function in which a designated portion of the image displayed by the image projector blinks while being displayed by the image projector.

43. A system according to claim 41, wherein the control panel includes a highlight function in which a graphic is added to the image displayed by the image projector to highlight a designated portion of the image.

44. A system according to claim 41, wherein the image projector is a laser projector.

45. A system according to claim 41, wherein the image projector displays the image in direct proportion dimensionally to the object of interest.

46. A system according to claim 43, wherein the graphic is a circle.

47. A system according to claim 43, wherein the graphic is an arrow.

48. A system according to claim 43, wherein the image processing unit causes the graphic to follow the designated portion of the image.

49. A system according to claim 41, wherein:
the imager is configured to capture images of a plurality of objects of interest in a field of view and generate image data from each captured image that comprises information of each object of interest that cannot be detected by the naked eye;
the image processing unit extracts a portion of the image data of the objects of interest and transforms the extracted portion of the image data into a viewable format; and
the image projector displays an image in accordance with the extracted portion of the image data transformed by the image processing unit respectively onto each object of interest from which the image data was generated.

50. A system according to claim 49, further comprising a control panel configured to provide image controls in response to inputs made through the control panel, wherein each image control is configured to adjust the operation of at least one of the imager, the image processing unit, and the image projector.

51. A system according to claim 50, wherein the control panel includes a blinking function in which the image displayed by the image projector on at least one designated object of interest blinks while being displayed by the image projector.

52. A system according to claim 50, wherein the control panel includes a highlight function in which at least one graphic is added to the image displayed by the image projector to highlight at least one object of interest.

53. A system according to claim 52, wherein the graphic is a circle.

54. A system according to claim 52, wherein the graphic is an arrow.

55. A system according to claim 52, wherein the image processing unit causes the graphic to follow the highlighted object of interest.

56. A method for displaying properties on an object comprising:
capturing an image of at least one object of interest in a field of view with an imager that can detect information of the object of interest that cannot be detected by the naked eye;
generating image data from the captured image, wherein the image data represents the information of the object of interest that cannot be detected by the naked eye;
extracting a portion of the image data and transforming the extracted portion of the image data into a viewable format; and
displaying with an image projector an image in accordance with the transformed extracted portion of the image data onto the object of interest.

57. A method according to claim 56, wherein the imager is a thermal imager, and the captured image is a thermal image of the object of interest.

58. A method according to claim 57, wherein the object of interest is a person, and a thermal image of the person is displayed onto the person in direct proportion dimensionally to the person.

59. A method according to claim 56, wherein the imager is an X-ray machine, and the captured image is an X-ray of the object of interest.

60. A method according to claim 59, wherein the object of interest is a container including contents, and an X-ray image of the contents of the container is displayed onto a wall of the container in direct proportion dimensionally to the contents.

61. A method according to claim 56, further comprising:
adjusting electronically a position and size of the image displayed by the image projector; and
adjusting mechanically a relative position between the imager and the image projector.

62. A method according to claim 61, further comprising aligning the image displayed by the image projector based on the electronic and mechanical adjustments so that the displayed image is in direct proportion dimensionally to the object upon which the image is projected.

63. A method according to claim 56, further comprising:
receiving frames of the image data from the imager in real time; and
maximizing a contrast between the objects of interest and a background in each frame received from the imager in real time.

64. A method according to claim 63, further comprising:
identifying a vector line wherever white image data meets black image data in each frame in real time;
creating a vector outline frame based on the identified vector lines for each respective frame of image data received from the imager in real time; and
providing the vector outline frames to the image projector,
wherein the image projector displays the image in accordance with the provided vector outline frames.

65. A method according to claim 63, further comprising:
generating raster line data where the white image data is present in each respective frame of image data received from the imager in real time; and
creating raster line frames based on the generated raster line data for each respective frame of image data received from the imager in real time; and
providing the raster line frames to the image projector,
wherein the image projector displays the image in accordance with the provided raster line frames.

66. A method according to claim 56, further comprising providing image controls in response to inputs made through a control panel, wherein each image control is configured to adjust the operation of at least one of the imager and the image projector.

67. A method according to claim 66, further comprising causing a designated portion of the image displayed by the image projector to blink while being displayed by the image projector in response to a predetermined image control.

68. A method according to claim 66, further comprising causing a graphic to be added to the image displayed by the image projector to highlight a designated portion of the image in response to a predetermined image control.

69. A method according to claim 56, wherein the image projector is a laser projector.

70. A method according to claim 56, wherein the image is displayed in direct proportion dimensionally to the object of interest.

71. A method according to claim 68, wherein the graphic is a circle.

72. A method according to claim 68, wherein the graphic is an arrow.

73. A method according to claim 68, wherein the graphic is caused to follow the designated portion of the image.

74. A method according to claim 56, wherein:
the step of capturing an image comprises capturing images of a plurality of objects of interest in a field of view with an imager that can detect information of the objects of interest that cannot be detected by the naked eye;
the step of generating image data comprises generating image data from each captured image, wherein the image data represents the information of each object of interest that cannot be detected by the naked eye;
the extracting step comprises extracting a portion of the image data of the objects of interest and transforming the extracted portion of the image data into a viewable format; and
the displaying step comprises displaying with an image projector an image in accordance with the extracted portion of the image data transformed by the image processing unit respectively onto each object of interest from which the image data was generated such that the displayed image is in direct proportion dimensionally to the objects of interest.

75. A method according to claim 74, further comprising providing image controls in response to inputs made through a control panel, wherein each image control is configured to adjust the operation of at least one of the imager and the image projector.

76. A method according to claim 75, further comprising causing the image displayed by the image projector on at least one designated object of interest to blink while being displayed by the image projector in response to a predetermined image control.

77. A method according to claim 75, further comprising causing at least one graphic to be added to the image displayed by the image projector to highlight at least one object of interest in response to a predetermined image control.

78. A method according to claim 77, wherein the graphic is a circle.

79. A method according to claim 77, wherein the graphic is an arrow.

80. A method according to claim 77, wherein the graphic is caused to follow the highlighted object of interest.

81. A method for detecting and revealing life forms that otherwise are difficult to detect with the naked eye, comprising:
capturing, with a thermal imager, a thermal image of one or more life forms present in a field of view;
generating image data from the captured thermal image, wherein the image data represents at least the location(s) and the shape(s) of the life form(s) detected;
transforming at least a portion of the image data into a viewable format; and
displaying, with an image projector, a real time image in accordance with the transformed image data onto the detected life form(s) such that the displayed image is in direct proportion dimensionally to the detected life form(s) to render the location(s) and the shape(s) of the detected life form(s) visible to the naked eye.

82. A method according to claim 81, wherein the life form(s) include one or more persons, and the image is displayed onto the detected person(s) in direct proportion dimensionally to the detected person(s).

83. A method according to claim 82, further comprising causing a designated portion of the image displayed by the image projector to blink.

84. A method according to claim 82, further comprising adding at least one graphic to the image displayed by the image projector to highlight at least one designated person.

85. A method according to claim 84, wherein the designated person(s) highlighted by the graphics are enemy combatants.

86. A method according to claim 84, wherein the graphic is a circle.

87. A method according to claim 82, wherein the image displayed onto the detected person(s) is an outline of each detected person.

88. A method according to claim 82, wherein the image displayed onto the detected person(s) is a raster line image of each detected person.

89. A method for detecting and revealing the contents of a container that are not visible to the naked eye, comprising:
capturing an image of the contents of a container with an imager that can detect information of the contents through a wall of the container;
generating image data from the captured image, wherein the image data represents at least the locations and the shapes of the contents detected;
transforming at least a portion of the image data into a viewable format; and
displaying, with an image projector, a real time image in accordance with the transformed image data onto the exterior of the container such that the displayed image is in direct proportion dimensionally to the detected contents to render the location and the shape of the detected contents visible to the naked eye.

90. A method according to claim 89, wherein the image is displayed onto the exterior of the container in direct proportion dimensionally to the detected contents.

91. A method for detecting and revealing stress concentrations in a structure, comprising:
capturing, with a thermal imager, a thermal image of at least a portion of a structure;
generating image data from the captured thermal image, wherein the image data represents at least the location(s) of detected stress concentration;
transforming at least a portion of the image data into a viewable format; and
displaying, with an image projector, an image in accordance with the transformed image data onto the structure such that the displayed image is in direct proportion dimensionally to the structure to render the location(s) of the detected stress concentrations visible to the naked eye.

92. A method according to claim 91, wherein the structure is a bridge.

93. A method for detecting and revealing hot spots in an apparatus, comprising:
capturing, with a thermal imager, a thermal image of at least a portion of an apparatus;
generating image data from the captured thermal image, wherein the image data represents at least the location(s) of detected hot spots;
transforming at least a portion of the image data into a viewable format; and
displaying, with an image projector, an image in accordance with the transformed image data onto the apparatus such that the displayed image is in direct proportion dimensionally to the apparatus to render the location(s) of the detected hot spots visible to the naked eye.

94. A method according to claim 93, wherein the apparatus is an electrical power apparatus.
